(19) United States
(12) Patent Application Publication
(10) Pub. No.: US 2014/0156443 A1
(43) Pub. Date: Jun. 5, 2014

(54) Online Marketplace System

(71) Applicant: Agent 20, Inc., Auburn, AL (US)

(72) Inventors: Joerg Wesche, Auburn, AL (US); Klaas J. Van der Reijden, Auburn, AL (US)

(73) Assignee: Agent 20, Inc., Auburn, AL (US)

(21) Appl. No.: 14/094,593

(22) Filed: Dec. 2, 2013

Related U.S. Application Data
(60) Provisional application No. 61/732,365, filed on Dec. 2, 2012.

(51) Int. Cl. G06Q 30/06

(52) U.S. Cl. CPC G06Q 30/0611
USPC 705/26.4

(57) ABSTRACT

An online marketplace system comprising a customer profile associated with at least one customer, a vendor profile associated with each of the plurality of vendors, a main dashboard associated with the customer profile, a vendor dashboard associated with the vendor profile and an application server configured for storing details of the customer profile, the vendor profile, the main dashboard and the vendor dashboard in the online market system. The online market system allows the at least one customer to control and coordinate the requirements to the plurality of vendors in a simple and efficient manner. Embodiments of the system and method are described, and may be used for coordinating requirements of at least one customer related to at least one service of interest to a plurality of vendors.

### RELATED APPLICATIONS

This application claims priority from the U.S. provisional application with Ser. No. 61/732,365 filed on Dec. 2, 2012. The disclosure of the provisional application is incorporated herein as if set out in full.

### BACKGROUND OF THE DISCLOSURE

1. Technical Field of the Disclosure

The present invention relates in general to systems and methods for conducting online business. More specifically, the present disclosure relates to an improved system and method for coordinating requirements of a customer related to goods and/or services to a plurality of vendors via an online marketplace.

2. Description of the Related Art

Online marketplaces provide a means for selling products and services over the Internet. Such online systems offer a wide variety of products and services to customers of all sorts, providing the convenience of purchasing products from a single place. Online marketplaces help drive new business for online vendors by providing benefits of increased sales. Either vendors or third party owners own such systems. The third party owners procure the service or product from the vendors at a low price and sell the service or product to the customer at a higher price. In some instances the third party owners referring the customer to the vendor receive a commission from the vendor for the referral.

Conventional online marketplaces for conducting business have considerable drawbacks. For example, conventional systems do not allow the customer to communicate their requirements related to a specific service or product to the vendors. Existing systems are static, expensive and exploit the vendors with high price rates. The vendors typically receive only a percentage of the profit while a large volume of the revenue leaks to the website owners. In addition, the vendors and the customer cannot directly control these systems. Also, these systems do not allow the vendors to evaluate other vendors who are making offers to the customer. Finally, these systems do not allow the vendors to offer added values to the customer. Moreover, these systems allow one vendor to win.

There are several other online market systems in which the sellers retail the service or product at a higher price and redirect the customer to the actual service provider's website to receive a significant commission. Here, the pricing varies insignificantly due to price parity agreements between the seller and the service provider. The service providers do not lower the price so as not to dilute the brand, and the retailer does not lower the price, as he/she needs large margins to cover overhead cost and cost of sale. A major drawback associated with these systems is that these systems do not allow buyers to publish their requirements to the sellers. Thus, the buyers are forced to buy the product or service offered by the sellers due to lack of choice. Furthermore, these systems are strictly money driven. The current online market culture fuels this process.

Therefore, there is a need for a system that will provide a cost effective and improved means for communicating requirements of a customer related to goods and/or services to a plurality of vendors. Such a system would allow the vendors to view customer requirements and provide competitive offers to meet the requirements. Such a system would provide a free market platform for the vendors to entice customers through flexible price ranges and added values. Further, such a needed system would allow the vendors and customers to directly control the marketplace in such a way that customers can stop the marketplace and collection of competitive offers at any time, and vendors not in a leading position can exit the marketplace at any time. This system would allow the customer to choose from the best offers provided by the vendors in accordance with the customer's requirements. Furthermore, there are no binding contracts, allocated inventories or agreed pricing to underline the free market concept. Such a system would be simple, inexpensive, and easy to use. Finally, this system would also provide an efficient means for the vendors to compete for business by competitively placing offers against each other through a sophisticated web based platform.

### SUMMARY OF THE DISCLOSURE

To minimize the limitations found in the prior art and to minimize other limitations that will be apparent upon the reading of the specifications, the preferred embodiment of the present invention provides a system and method for regulating an online marketplace related to at least one service of interest. The present invention discloses in detail a web-based system and method for controlling and coordinating requirements of a customer pertaining to at least one service of interest to a plurality of vendors. The system is primarily intended for regulating an online marketplace for hotel reservations. However, other types of services and online marketplaces may be utilized as well without departing from the scope of the present invention.

The present invention provides an online marketplace platform that allows the customers to communicate their requirements related to at least one service of interest to a plurality of vendors. The system includes a customer profile associated with at least one customer, a vendor profile associated with each of the plurality of vendors, a main dashboard associated with the customer profile, a vendor dashboard associated with each of the vendor profiles and an application server configured for storing details of the customer profile, each vendor profile, the main dashboard and the vendor dashboard in the online market system. The online market system allows the at least one customer to control and coordinate requirements related to the at least one service of interest to the plurality of vendors in a simple and efficient manner.

In accordance with another aspect of the present invention, a method for coordinating requirements of at least one customer related to at least one service of interest to a plurality of vendors is disclosed.

A first objective of the present invention is to provide a system that will offer a cost effective and improved means for communicating requirements of a customer related to goods or services to a plurality of vendors.

A second objective of the present invention is to provide a system that would allow the vendors to view customer requirements and provide competitive offers to meet the requirements.

A third objective of the present invention to provide a system that would provide a free market platform for the vendors to entice customers through flexible price ranges and complementary added values.

Another objective of the present invention is to provide a system that would allow the vendors and customers to directly control the marketplace in that the customer can stop the marketplace and collection of offers at any time and the vendor can exit the marketplace so long as the vendor is not in a leading position at the market place.

Yet another objective of the present invention to provide a simple, inexpensive, and easy to use system that would allow the customer to choose from the best offers provided by the vendors in accordance with his or her requirements.

Still another objective of the present invention is to provide an efficient means for the vendors to compete for business by providing competitive offers against each other through a sophisticated web based platform.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a schematic diagram of an online market system for coordinating requirements of at least one customer related to at least one service of interest to a plurality of vendors;

FIG. 2 is a generalized flow chart of a method for coordinating requirements of at least one customer related to at least one service of interest to a plurality of vendors via the online market system in accordance with the preferred embodiment of the present invention;

FIG. 3 is an operational flow chart of a method for selecting an offer from the descending range of individual offers and purchasing the at least one service of interest by the customer in accordance with the preferred embodiment of the present invention;

FIG. 4 is an operational flow chart of a method for coordinating requirements of at least one customer related to at least one service of interest to a plurality of vendors via the online market system in accordance with an exemplary embodiment of the present invention;

FIG. 5 is an exemplary embodiment of the system integrated into an existing hotel reservation system; and

FIG. 6 is a pictorial representation of the online market system in accordance with an exemplary embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

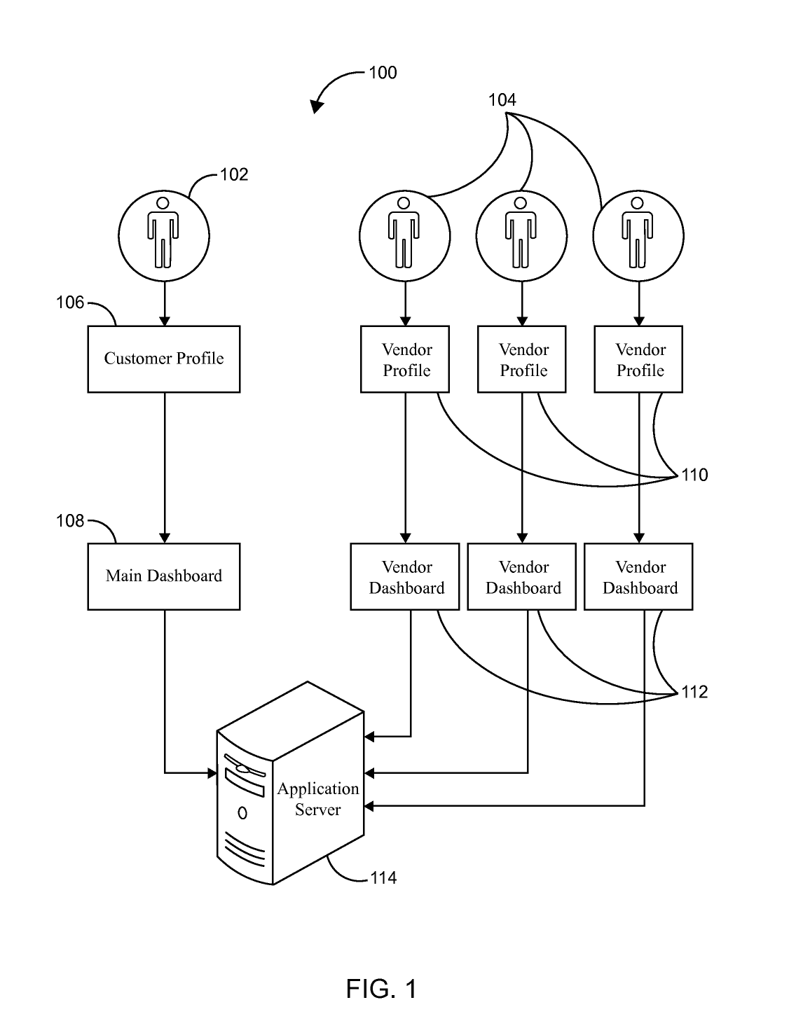

Turning first to FIG. 1, a schematic diagram of an online market system 100 for coordinating requirements of at least one customer 102 related to at least one service of interest to a plurality of vendors 104 is illustrated. The system 100 comprises a customer profile 106 associated with the at least one customer 102, a vendor profile 110 associated with each of the plurality of vendors 104, a main dashboard 108 associated with the customer profile 106, a vendor dashboard 112 associated with each vendor profile 110 and an application server 114 configured for storing details of the customer profile 106, each vendor profile 110, the main dashboard 108 and the vendor dashboard 112 in the online market system 100. The online market system 100 allows the at least one customer 102 to control and coordinate requirements related to the at least one service of interest to the plurality of vendors 104 in a simple and efficient manner.

For accessing the system 100, the at least one customer 102 utilizes the customer profile 106 to log in to the system 100 via a web browser installed on the respective computers of the vendors 104 and the customer 102. After creating the customer profile 106, the customer 102 may log in to the system 100 and open a new request for offers in the system 100. Each request for offers is entered into the system 100 by the at least one customer 102. The system 100 then allows the customer 102 to enter the requirements related to the at least one service of interest. In the preferred embodiment of the present invention, the customer can enter the requirements pertaining to hotel reservation selected from a group consisting of, but not limited to: name of the trip, destination, arrival and departure date, number of rooms, number of guests per room, desired hotel level, and desired maximum distance from the destination. The customer 102 can also set the time frame for which competitive offers may be submitted by selecting a pre-defined time frame in the system. Once these details are entered, the system 100 validates the entered data to ensure that all required information is available and valid. The customer 102 can open the marketplace for an offer by clicking on “Open Marketplace” button and the offer time will begin. The marketplace is kept open during the set pre-defined time frame entered by the at least one customer 102 wherein competitive offers will be collected. The customer 102 will then be automatically redirected to the main dashboard 108 of the system 100, which allows the customer 102 to view new and past offers. The system 100 also allows the customer 102 to view the last three offers made, or in alternative embodiments the last n number of offers made. The customer 102 can view pictures and descriptions of all services/products offered by the vendor on the main dashboard 108. The customer 102 can also view the locations of hotels in relation to desired destinations/landmarks using a map feature incorporated in the main dashboard 108, such as but not limited to Google Maps by Google. The main dashboard 108 also displays pictures and reviews about the vendors 104 to the customer 102.

Each of the plurality of vendors 104 also registers the vendor profile 110 in the system 100 and the system 100 accepts these vendor profiles. In the preferred embodiment, vendors 104 are hotels participating in the online marketplace. Once registration is completed, the vendor 104 will be directed to the vendor dashboard 112. The vendor dashboard 112 allows the plurality of vendors 104 to view new and past customer requests. Each of the plurality of vendors 104 can view all the open offers and marketplace-pertinent data such as but not limited to arrival, departure, number of rooms, total number of room nights and resulting average price per room/night, remaining marketplace time, current lead price and current lead property in the vendor dashboard 112. The main dashboard 108, the vendor dashboard 112, all customer profile 106 information and all vendor profile 110 information are stored in the application server 114 of the online market system 100. Like the customer 102, by clicking on a specific marketplace, each of the plurality of vendors 104 can also see details on each open marketplace and offers submitted thereto, such as last three offers made, or last n offers made. If a vendor 104 detects a new offer in which it is not yet participating, the vendor 104 can click on the offer to be directed to the detailed vendor dashboard. The system 100 filters the requirements provided by the customer 102, identifies a plurality of pre-qualified vendors and communicates the requirements to the plurality of pre-qualified vendors on the vendor dashboard and/or via a communication means. The communication means is selected from the group consisting of, but not limited to: e-mail, a short-message-service (SMS) and/or instant-messaging services. The system 100 allows the plurality of vendors 104 to view customer requirements and provide competitive offers to meet the requirements.

In response, the vendors 104 provide at least one price range with or without one or more complimentary added values to the customer 102 such that the system collects a plurality of prices ranges from a plurality of vendors. The system 100 then validates the entered data to ensure that all required information is available and valid. Provided that the information is correct, the system 100 consolidates all data and via the algorithm and on behalf of the hotels divides the plurality of price ranges and posts these ranges in descending range of individual offers over the pre-defined time frame selected by the customer 102. The customer 102 makes a purchasing decision and selects an offer from the three leading offers either at any time when the offer is open or at the very end of the pre-defined time frame. In alternative variations, greater or fewer than three offers may be shown. The customer 102 has the ability to end the offer at any time when the marketplace is open.

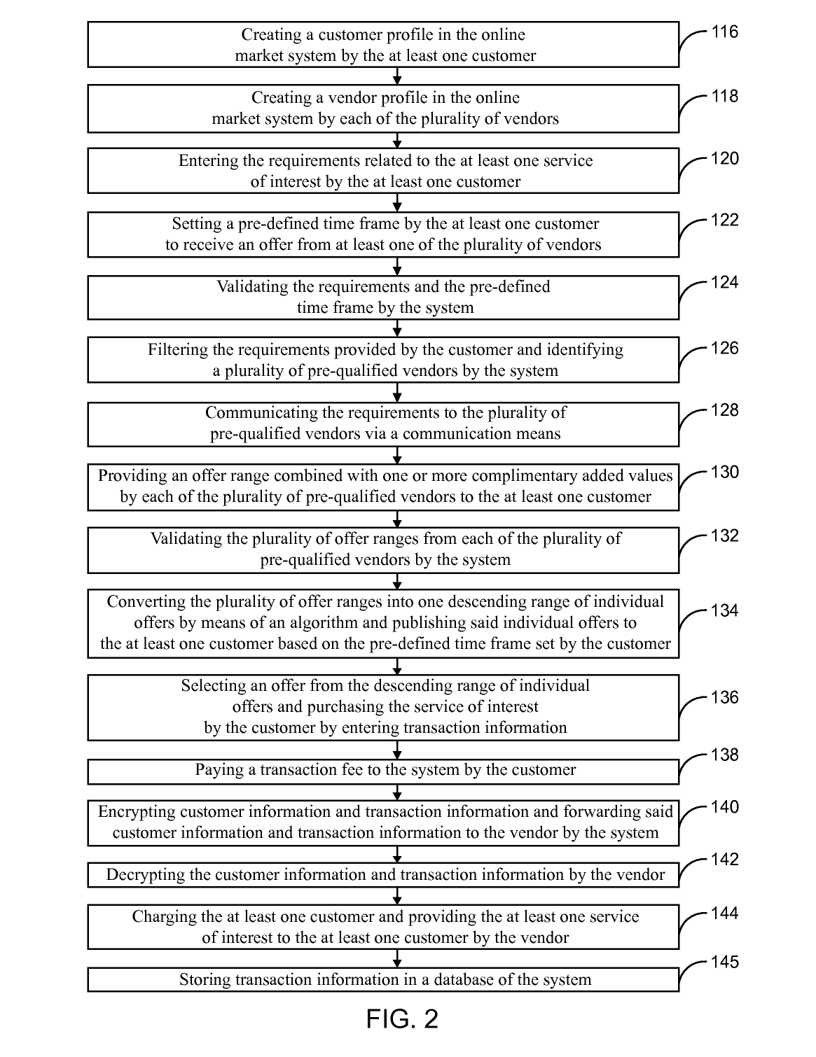

Referring to FIG. 2, a generalized flow chart of a method for coordinating requirements of at least one customer related to at least one service of interest to a plurality of vendors via the online market system 100 in accordance with the preferred embodiment of the present invention is illustrated. Initially, a customer profile is created in the online market system by the at least one customer as shown in block 116. Next, a vendor profile is created in the online market system by each of the plurality of vendors as indicated at block 118. The requirements related to the at least one service of interest are entered by the at least one customer as shown in block 120. Then, a pre-defined time frame is set by the at least one customer to receive offers from at least one of the plurality of vendors as indicated at block 122. Then, the requirements and the pre-defined time frame are validated by the system as shown in block 124. The requirements provided by the customer are filtered and a plurality of pre-qualified vendors is identified by the system as indicated at block 126. The requirements are communicated to the plurality of pre-qualified vendors via a communication means as shown in block 128. Then, an offer range combined with or without one or more complementary added values is provided by each of the plurality of pre-qualified vendors to the system as indicated at block 130. The offer ranges from the plurality of pre-qualified vendors are validated by the system as shown in block 132. The offer ranges from the plurality of pre-qualified vendors are then converted into one descending range of individual offers by means of an algorithm and said individual offers are published to the at least one customer based on the pre-defined time frame set by the customer as indicated at block 134. An offer from the descending range of individual offers is selected and the at least one service of interest is purchased by the customer by entering transaction information as shown in block 136. In an alternative embodiment of the invention the system 100 alerts the customer by activating an audible alert on a mobile communication device (not shown). Then, as indicated at block 138, the customer pays a transaction fee to the system. The system then encrypts customer information and transaction information and forwards said customer information and transaction information including, but not limited to name, arrival date, departure date, price etc. to the vendor as shown in block 140. The customer information and the transaction information is then decrypted by the vendor as shown in block 142. The at least one customer is then charged by the vendor, and the at least one service of interest is provided to the at least one customer by the vendor as indicated at block 144. Finally, the transaction information is stored in a database of the system as shown in block 145. In another alternative embodiment of the invention the system 100 allows the customer to print a hotel confirmation receipt (not shown) using a printer (not shown).

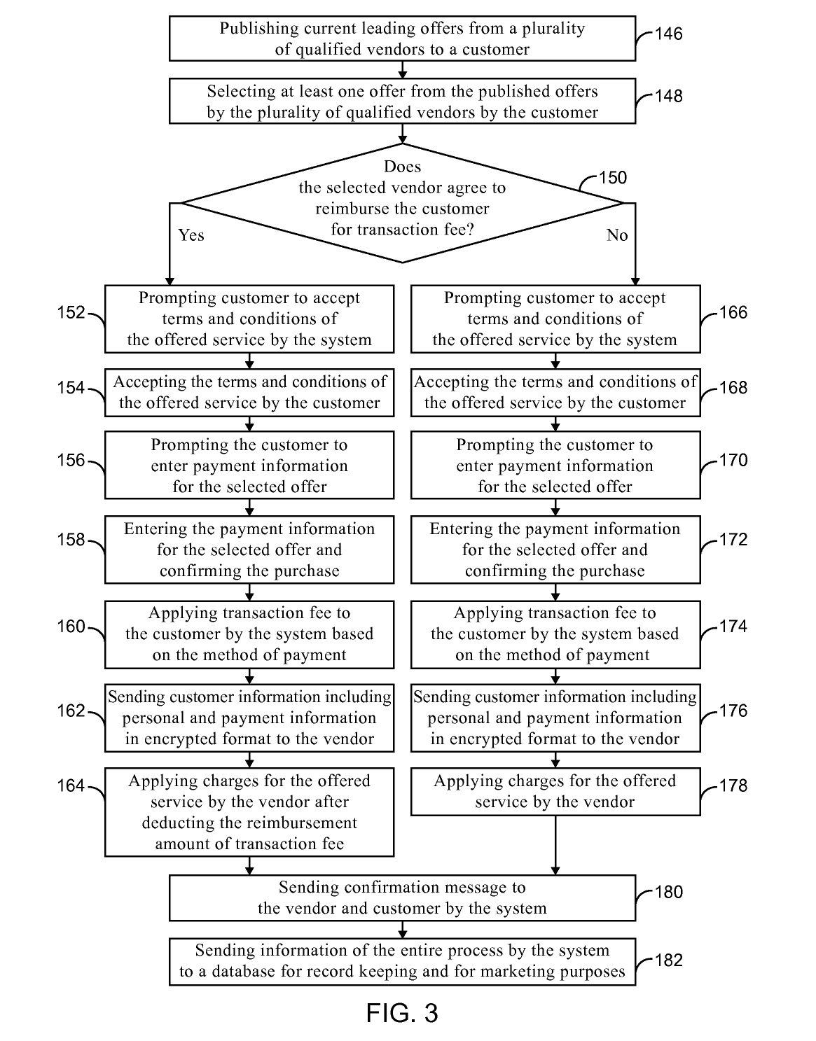

Referring to FIG. 3, an operational flow chart of a method for selecting an offer from the descending range of individual offers and purchasing the service of interest by the customer in accordance with the preferred embodiment of the present invention is illustrated. Initially, based on requirements of at least one customer for a selected service, the online market system publishes current leading offers from a plurality of qualified vendors to the at least one customer as shown in block 146. Next, the customer selects at least one offer from the published offers by the plurality of qualified vendors as indicated at block 148. The system will then check whether the selected vendor will reimburse the transaction fee to the customer as shown in block 150. If the selected vendor is willing to refund the transaction fee to the customer then the system will prompt the customer to accept terms and conditions of the offered service as indicated at block 152. The customer can go through the terms and conditions of the selected vendor and may accept the terms and conditions of the offered service by the system as shown in block 154. Next, the system will prompt the customer to enter payment information for the selected offer as indicated in block 156 and the customer can enter the payment information for the selected offer, thereby confirming the purchase as indicated at block 158. The system may incur a transaction fee to the customer based on the method of payment as shown in block 160. After receiving the amount, the system will send customer information, including personal and payment information in encrypted format to the selected vendor as indicated at block 162. Next, in the payment section, the system will provide charges to the vendor, after deducting the reimbursement amount of the transaction fee, for the services offered by the vendor as indicated at block 164. If the selected vendor is not willing to refund the transaction fee to the customer, the system will prompt the customer to accept terms and conditions of the offered service as indicated at block 166. The step of accepting the terms and conditions of the offered service by the system is shown in block 168. The system thereafter prompts the customer to enter payment information for the selected offer as indicated in block 170. The customer can enter the payment information for the selected offer, thereby confirming the purchase as indicated at block 172. Then, similar to block 160, the system may apply a transaction fee to the customer based on the method of payment as shown in block 174 and will send customer information including personal and payment information in encrypted format to the selected vendor once the payment has been received, as indicated at block 176. Since here the vendor is not reimbursing the transaction fee, the system will apply charges set for the offered service by the vendor, without deducting the transaction fee, as shown in block 178. Once the customer confirms the booking decision, the system will send a confirmation message to the vendor and customer as shown in block 180. Finally as indicated at block 182, the information of the entire process may be stored in a database for record keeping and for marketing purposes.

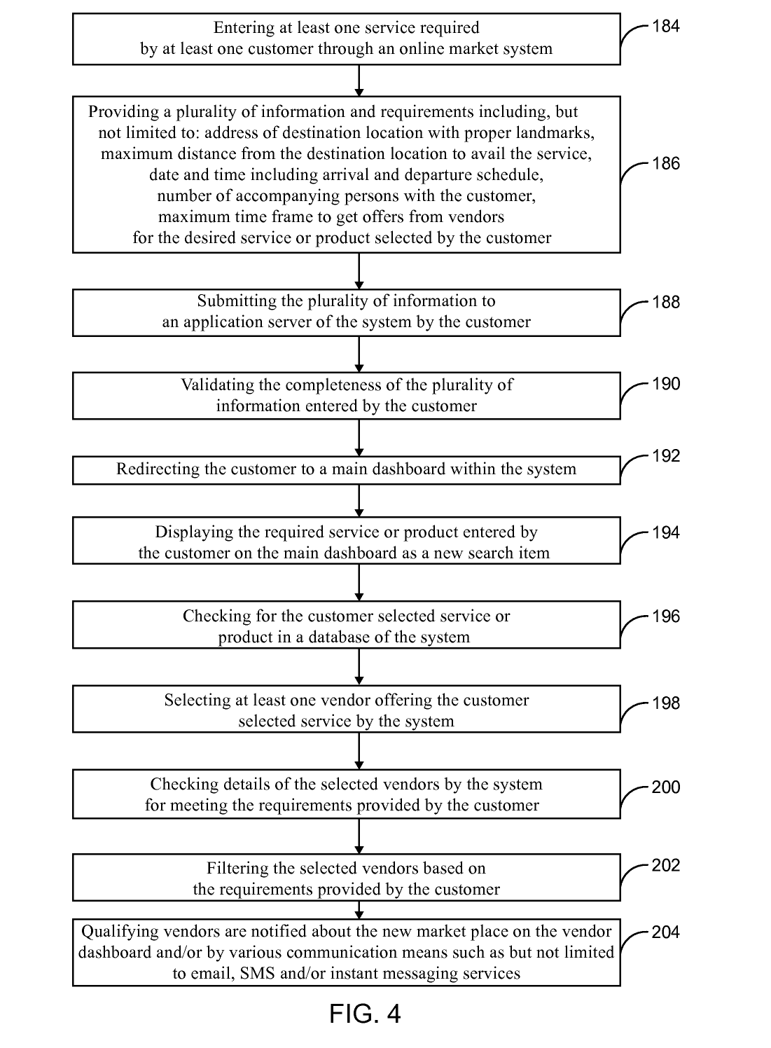

FIG. 4 is an operational flow chart of a method for coordinating requirements of at least one customer related to at least one service of interest to a plurality of vendors via the online market system 100 in accordance with an exemplary embodiment of the present invention. This exemplary embodiment illustrates the method for coordinating requirements of at least one customer related to a service or product to a plurality of vendors via the online market system 100. Initially, at least one customer may enter at least one service or product detail that is required by the customer through an online market system as shown in block 184. Then, the customer may provide a plurality of information and requirements related to the desired service or product, such as in the case of a hotel, requirements that include but are not limited to: address of destination location with proper landmarks, maximum distance from the destination location to avail the service, date and time including arrival and departure schedule, number of accompanying persons with the customer, maximum time frame to get offers from vendors etc. as indicated at block 186. The information and requirements provided by the customer for the desired service or product are submitted to the system and may be stored in the application server, as indicated at block 188. Now as shown in block 190, the system will check for the completeness of the entered information and validate the plurality of information entered by the customer. If all the necessary information is collected, the customer will be redirected by the system to a main dashboard as indicated at block 192, and the customer's desired service or product will be displayed in the main dashboard as a new search item, indicated at block 194. Next, the system will check for the customer's desired service or product and whether any vendor within the database is offering that desired service or product as shown in block 196 and will select a vendor offering the customer selected service or product as indicated at block 198. Next, the system will check details of the selected vendors for meeting the requirements provided by the customer as indicated at block 200 and will filter the selected vendors based on these requirements as indicated at block 202. Finally, as shown in block 204, the qualifying vendors are notified about the new marketplace on the vendor dashboard and/or by various communication means, such as, but not limited to e-mail, SMS or instant messaging service.

The method for coordinating requirements of at least one customer 102 related to at least one service of interest to a plurality of vendors 104 via the online market system 100 can most simply be explained using an example of placing a hotel reservation during a trip. In this example, the system 100 provides the customer 102 an option to name the trip. Then the system 100 will prompt the customer 102 to enter a plurality of information and details about the trip. The customer 102 may enter details including, but not limited to destination location including city name, street name and proper landmarks for finding the exact location of the hotel. Then, the date of arrival at the city and the date of departure will be collected. Then for the purpose of booking hotel rooms, the customer 102 will be asked to enter the number of rooms and the number of guests. The customer 102 is also allowed to enter the desired hotel level or rating and maximum distance of hotel from destination location. In addition, the customer 102 may enter the pre-defined time frame he/she will be willing to wait for the offers through the system 100. All of the above information, when submitted, will be stored in the application server 114.

The system 100 then checks if all the necessary details have been entered. If yes, then the system 100 redirects the customer 102 to the main dashboard 108, where the system 100 displays the main dashboard 108 with the new search item displayed. The search item will be displayed in an exemplary embodiment as, “customer is seeking hotel in a city “X” from date “A” to date “B”, maximum distance to destination place “Y” is “d” miles and hotel level/rating is “h”. In this exemplary embodiment, the system 100 then checks the database for hotels and may check for one or more of the following conditions: The system 100 will check whether the hotel is located in city “X”, if there are hotels then the system 100 will move on and check the next condition. But, if there are no hotels located at city “X”, the system 100 will check for hotels in a neighbor city. If any hotel in the neighbor city can be found from the database, the system 100 will check the next condition. Alternately, if there are no hotels at city “X” or the neighboring city, the system 100 displays the unavailability of hotels in the particular area to the customer 102. If there are hotels in the appropriate area, then the system 100 will check the condition, whether the hotel is located <“d” miles from destination place “Y”. If there are no hotels within “d” miles from destination place “Y”, then the system will display the unavailability of hotels in the particular area to the customer. If there are hotels, then the system will check the condition of whether the hotel level/rating is “h” or one level/rating above, and if no hotels are of “h” levels or rating or one level above, then the system 100 will display the unavailability of hotels in the particular area. In an alternative embodiment the system 100 will check only hotels of “h” level and will display the unavailability of hotels if there are no hotels of “h” level. In yet an additional alternative embodiment the system 100 will check if there are hotels of ‘h’ level and at least one level above and display unavailability of hotels only if there are no hotels of ‘h’ and at least one level above. If the criteria are met and hotels will be displayed by the system 100, then the system 100 will pre-filter hotels that meet the customer's requirements and the filtered results will be made available to the customer 102.

Each of the plurality of vendors 104 can see all offers on the vendor dashboard 112 and filter them based on various criteria such as “new offers”, “market place the hotel leads”, “offers for today” etc. If a hotel detects a new market place in which it is not yet participating, it can click on the market place and will be led to the “Detailed hotel dashboard”. The vendor 104 can also view offer ID, arrival and departure date, number of rooms, resulting average price per room/night, remaining bid time, current lead price and current lead property in the vendor dashboard. Each of the plurality of vendors 104 can view other competing vendors who have bid on the business and/or the top leading vendors in the vendor dashboard 112.

In order to place an offer, the vendor 104 clicks on “Enter A Price Range,” which consists of two fields, the “high” and the “low” offer. If no offers had been previously entered, then both fields will be empty and the vendor can enter any high amount and any low amount. Once the rates have been entered, the vendor 104 will have the option of providing complementary added values to the offer. By scrolling over the individual complementary added values, the system will display a brief description of the complementary added values. The vendor 104 can pick complementary added values by clicking on them, thereby submitting them to the system 100. The system 100 may require the vendor 104 to confirm the rates and selected values by re-entering his password. Once the values are entered and the vendor 104 submits the offer, the offer is entered into the system 100. Preferably, a waiting time is provided by the system 100 before any offers are shown to the customer 102 within which additional hotels may first enter additional price ranges to the system 100. Preferably, during this time wherein additional price ranges are collected from additional vendors, each new vendor cannot yet see the price ranges provided by vendors 104. No offers will be presented to the customer 102 until a certain number of offers are collected or a certain amount of time transpires.

Once the set amount of offers has been collected or the waiting time has expired, the offer collection mechanism may be modified. In one embodiment, the system 100 will not accept price ranges having an upper bound higher than the lowest offer received. If the lowest offer received is $100, then the system 100 will not accept price ranges including or exceeding this amount. The vendor 104 can enter a higher price than the current bid price, but the system 100 will ignore the higher price and internally use the current lowest offer and the low price entered by the vendor 104 as the accurate range. In alternative embodiments of the invention, the system 100 will accept price ranges exceeding this amount. In yet another embodiment, no price ranges will be accepted that include an upper limit at least 1% less than the current lowest amount previously accepted. In yet other embodiments the percentage less may be greater or less than 1%.

After the set amount of time or offers, the system 100 will display the price offered by vendors 104 to the customer 102 and all competitive vendors eligible to participate in the marketplace. The system 100 will first automatically and algorithmically determine specific offers to display based on the highest and lowest price from all of the accepted ranges. The algorithm may utilize numerous parameters, including, but not limited to: time, percentage of discount between the high and low rate of each hotel and system-set waiting time before actually posting the first offer so that a greater number of ranges may be compiled before a new marketplace is publicly revealed. As new hotels enter the marketplace and others drop out, the system 100 may recount the number of participating hotels after each change to the marketplace. Each time a new lead offer arrives, the system 100 refreshes the screen shown to the customer 102 and other vendors 104, wherein the system 100 drops the last offer and replaces it with the new lowest rate, pushing the previous leading offer to second position and the second lowest rate to third position. The system 100 allows the vendors to “leave the marketplace” at any time as long as the vendor is not in a leading position at the marketplace. When the marketplace for any given offer comes to an end, the vendor 104 is required to honor that offered rate for an additional time frame to allow the customer 102 to finalize the purchase by entering the personal information, payment information etc.

In an alternate embodiment, the system 100 allows the customer 102 to nudge the hotels that meet the requirements entered by the customer 102. The customer 102 can search for the particular hotel by entering the name of the hotel in a “search box.” If the hotel is registered in the system 100, the customer 102 can then click the “nudge” button and the hotel will receive a special notification indicating that the customer 102 is interested in an offer. In a preferred embodiment the customer 102 can nudge only one hotel in the system 100, but in another embodiment at least one hotel may be nudged and it still other embodiments other minimum numbers of hotels may be nudged.

Once the customer 102 finalizes his decision to purchase, the customer 102 clicks a button in this exemplary embodiment labeled “Love it! Book it!” located under the respective hotel. The system 100 then prompts the customer 102 and asks if he wants to stop the marketplace and purchase the displayed hotel at the current rate. If the customer 102 chooses the “cancel” button, the system 100 redirects the customer 102 to the main dashboard 108 for that particular offer, and the marketplace for that offer continues. The system 100 will continue with the marketplace and the algorithm will recalculate the timing for the distribution of the offers. The algorithm will continuously recalibrate to determine whether any hotels have left or new hotels have entered the market place and based on that, adjusts the time frequency in which the offers are placed in the system 100. This allows the system 100 to provide lowest price to the customer 102 at or very close to the end of the time set. If the customer 102 wants to confirm a reservation, the customer 102 needs to check a box confirming that he wants to book and the click the “continue” button.

The system 100 then prompts the customer 102 and asks if the reservation is for himself/herself or for someone else. If the reservation is for the customer 102, the system 100 generates a new display with pertinent customer information such as but not limited to name, address etc. as well as the hotel information, offer price, whether or not the system fee is being reimbursed by hotel, number of rooms, dates, hotel level/rating and amount of system fee. If the information is not correct, the customer 102 is directed to the customer profile to make changes as needed. If the customer 102 wants to reserve for someone else, the customer 102 may provide relevant information about the guest. Upon completion of all information, the customer 102 completes the transaction by entering the payment details and clicking “Make Purchase” button. The system 100 will send a confirmation e-mail to the customer 102, showing information such as but not limited to his or her name or name of the guests he or she booked for, and a notification e-mail to the winning vendor. Once the marketplace for an offer has ended, the offer will be displayed for a limited time as “closed” on the dashboards of competing vendors that did not win in that particular marketplace and “won” on the vendor dashboard of the winning hotel. Finally, the system 100 redirects the customer 102 back to the main dashboard 108 and displays the marketplace as “completed” until the checkout date has been reached.

Utilizing the system 100, the customer 102 may book multiple rooms. The customer 102 pays a flat transaction fee to the system 100 for performing an online reservation. The system fee may be calculated based on the hotel level/rating and the number of rooms booked. The system 100 may display the booking fee for each vendor 104 within the marketplace. In one embodiment, the customer 102 will be charged a flat booking fee. Each of the plurality of vendors 104 will have the option to offer one or more complimentary added values to the customer, one of them being the option to volunteer to reimburse the customer 102 for booking fee. These vendors will be highlighted via a specific icon on the system 100 to clearly indicate to the customer 102 if he or she will be refunded/reimbursed for the booking fee. If the customer 102 chooses a vendor willing to reimburse the customer 102, the booking fee will be deducted from the total price, resulting in a zero cost booking for the customer 102 and representing a low-cost reservation for the hotel. This allows each of the vendors 104 to receive the entire revenue and utilize part of the savings to make attractive offers while achieving an improved bottom line and bringing an advantage to the customer 102 as well. Once the customer makes a decision to purchase, he/she will complete the needed personal/financial information, acknowledge the terms of business and finalize the transaction by clicking the “purchase” button. Finally, the information about the transaction is stored in the database for record-keeping and marketing purposes. The system 100 will send a confirmation to the winning hotel and on the next refresh remove the market place from the vendor dashboard 112 of all competitive hotels that did not win. Preferably, the customer or individual for whom the customer booked a hotel then physically stays in the hotel, after which an e-mail will be sent to the customer 102, thanking the customer 102 for the business and allowing the customer 102 to rate their experience about the vendor they booked.

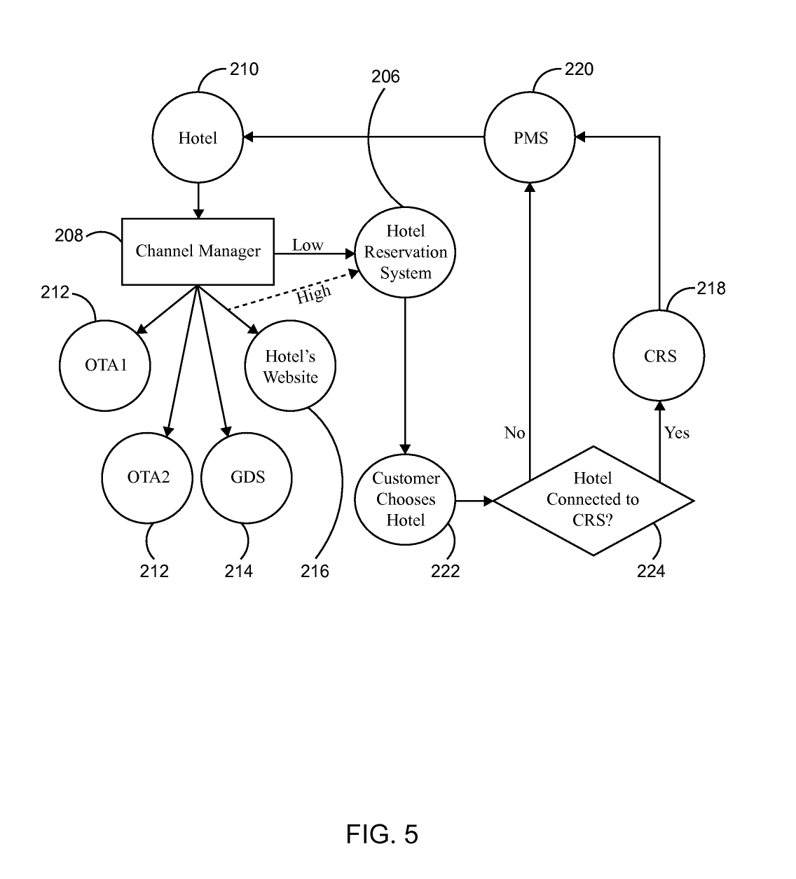

FIG. 5 is an exemplary embodiment of the system integrated into an existing hotel reservation system 206. This embodiment includes a Channel Manager 208, which is a conventional system that allows a hotel 210 to enter in one rate for a specific date and that dissects and distributes that rate to all channels, such as in this case to various Online Travel Agencies (OTAs) 212, the Global Distribution System (GDS) 214, and the hotel's website 216. To make it easier for the hotelier, the Channel Manager 208 takes the rate the hotelier enters, alters it based on the respective agreed pricing with each channel and publishes it real time. Usually, the GDS rate and the rate on the hotel's website 216 are “the full rate” the hotel 210 sells. If the hotel 210 has a 75% rate agreement with an OTA, the Channel Manager 208 will send a rate to that channel that is calculated by full rate×0.75. This embodiment also includes a Central Reservation System (CRS) 218, which is a centralized booking center for a large brand, and a Property Management System (PMS) 220, with which the hotel 210 itself manages the reservations, checks people in and out and posts charges to the guest bill. For example, if one were to book a hotel room with Hilton, the reservation goes first into the CRS 218 and then gets forwarded from there to the PMS 220.

In this embodiment, the hotel 210 posts rates via the Channel Manager 208. Usually, each channel gets one rate, but since the hotel reservation system 206 operates with a range, it implicitly includes a high rate and a low rate. The “high” rate will be the “published” rate that the hotel sells on the website 216 and the low rate can be defined in the Channel Manager 208 either as a hard number, i.e. “published rate minus $40” or as a percentage i.e. “published rate×0.72” as an example. These two rates represent the price range in which the hotel is willing to operate. If the customer now decides in favor of the hotel as indicated at block 222, the room may be booked two ways. If the hotel is part of a global chain and if the hotel is connected to a CRS as indicated at block 224, then reservation goes first into the CRS 218 and then gets forwarded from there to the PMS 220. If the hotel does not include a CRS 218, the reservation flows into the hotel's PMS 220, either directly or via the hotel's channel manager.

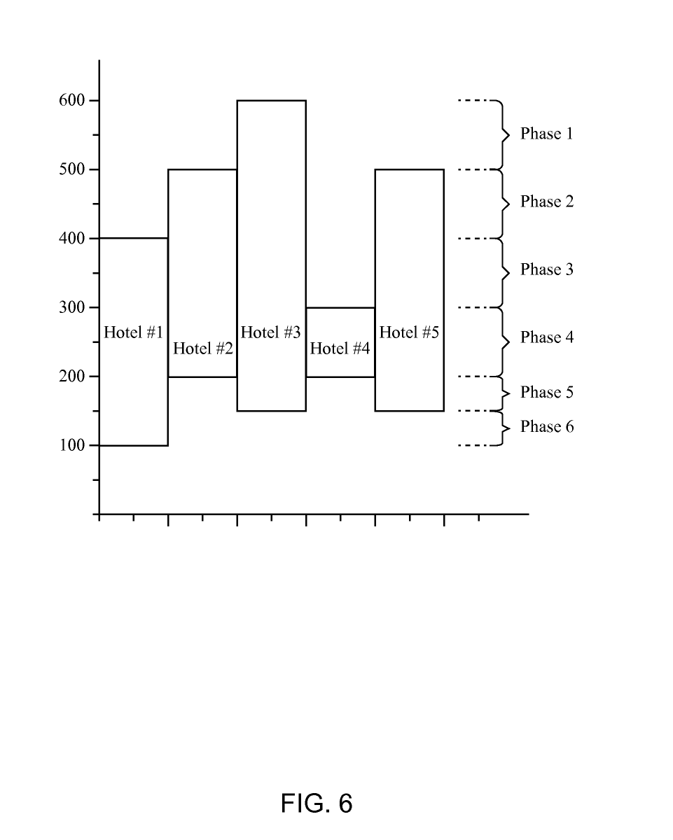

FIG. 6 is a pictorial representation of the online market system 100 in accordance with an exemplary embodiment of the present invention. This embodiment illustrates a particular instance in which five hotels are providing different offer ranges to the customer 102. The system 100 validates the offer range from the plurality of vendors 104 and converts the offer range to a descending range of individual offers by means of the algorithm. The system 100 is designed to start with the very highest rate collected and end up displaying for the customer the very lowest rate for each marketplace. In addition, the system 100 provides a waiting time for each offer. By applying a waiting time, the system 100 can collect more offer ranges and then start with the highest rate offered. For instance, if a customer is looking for a three star hotel in a certain city and the first offer range collected spans from a high of $200 to a low of $150, then if there was no waiting time then the only range seen by the customer would be $200 to $150. By allowing a wait time, other hotels are given the opportunity to bid, and if another hotel submits a range from a high of $400 to a low of $180, then the total range seen by the customer would be from $400 to $150. Thus, more accurate data regarding the total range of prices the customer could have paid are viewable by the customer.

Returning to the pictorial representation of the online market system 100 shown in FIG. 6, if no wait time was applied the system 100 may have stopped collecting bids after Hotel #1 submitted a range from a high of $400 to a low of $100. Continuing with this example, here Hotel #3 is shown to have submitted a bid of $600. In this instance, Hotel #3 has the highest starting offer and Hotel #1 has the lowest ending offer. This would lead to the fact that the price drop visible to the customer is from $600 to $100 instead of $400 to $100.

For instance, the algorithm divides the difference between the $600 high and $100 low into 100 bids of $5 and the waiting time is 100 minutes. This would lead to the system 100 theoretically creating 100 bids of $5.00 each to be placed in one-minute increments. In Phase 1, only one Hotel #3 will qualify to place bids. Since the hotel #3 cannot bid against itself, the $5.00 increments are placed “silently/internally” without displaying them to the customer. For 19 bids the system 100 maintains the original opening bid of $600 to the customer and with the 20th bid, the price will go to $500 and now display hotels #2 and #5. The bidding in Phase 2 continues amongst hotels #2, #3 and #5 until the rate goes to $400. At this point, hotel #1 joins and now all hotels except #4 participate. Once the price goes to $300, all hotels are in the running and being displayed in alternating order to the customer 102. Once the price is at $200, hotels #2 & #5 are underbid and will exit the marketplace. These hotels will be prompted on the vendor dashboard as well as via e-mail that they are underbid and can re-enter. Between the last three hotels, in phase 5 & 6, among Hotels #3 & #5 one of them will end up in second place, one at third place. Finally, Hotel #1 will be placed on top of the list as the winner at $100.

The present invention provides a method and computer program product for coordinating requirements of the customer 102 related to the at least one service of interest to a plurality of vendors 104 over the Internet. The system 100 includes a series of interconnected computers that can be directly connected to each other via data cables, telecommunication lines or wireless technology. The computer program product is housed at the series of interconnected computers and coordinates and controls the method. The present invention allows the vendors to view customer requirements and provide even more competitive offers against each other to meet the requirements. In this system, the customer 102 and the vendors 104 have complete control over the marketplace in that they can leave the marketplace at any time. Another advantage of the system 100 is that the competitive nature of the marketplace is enhanced due to the fact that the vendors 104 utilizing the system 100 can see which other vendor pursuing the customer 102 as well the prices offered by those vendors 104. Finally, the system 100 provides an easy to use, sophisticated web based platform that is designed to receive and transmit information in a simple and fast manner.

The foregoing description of the preferred embodiment of the present invention has been presented for the purpose of illustration and description. It is not intended to be exhaustive or to limit the invention to the precise form disclosed. Many modifications and variations are possible in light of the above teachings. For example, the appearance of the system 100 may be different depending on the web browser. Moreover, in some embodiments, the system 100 may include fewer components or additional components. It is intended that the scope of the present invention not be limited by this detailed description, but by the claims and the equivalents to the claims appended hereto.

What is claimed is:

1. An online market system for coordinating requirements of at least one customer related to at least one service of interest to a plurality of vendors, the system comprising:
a customer profile associated with the at least one customer, the customer profile being created to allow the at least one customer to access the system;
a plurality of vendor profiles associated with a plurality of vendors, the vendor profiles allowing the plurality of vendors to access the system;
a main dashboard associated with the customer profile, the main dashboard allowing the at least one customer to view new and past offers;
a plurality of vendor dashboards associated with a plurality of vendor profiles, the vendor dashboards allowing the plurality of vendors to view new and past customer requests; and
an application server configured for storing details of the customer profile, the vendor profiles, the main dashboard and the vendor dashboards in the online market system;
whereby the online market system allows the at least one customer to control and coordinate requirements related to the at least one service of interest to the plurality of vendors in a simple and efficient manner.

2. The system of claim 1 wherein the at least one customer can set a pre-defined time frame to receive an offer from at least one of the plurality of vendors.

3. The system of claim 1 wherein the system filters requirements provided by the customer, identifies a plurality of pre-qualified vendors and communicates the requirements to the plurality of pre-qualified vendors via a communication means.

4. The system of claim 1 wherein the system allows each of the plurality of vendors to view customer requirements and provides competitive offers to meet the requirements.

5. The system of claim 1 wherein each of the plurality of vendors can provide a plurality of offer ranges and complementary added values to the customer.

6. The system of claim 1 wherein the system validates the offer ranges from the plurality of vendors and converts the offer ranges to a descending range of individual offers by means of an algorithm.

7. The system of claim 1 wherein the descending range of individual offers are published to the at least one customer with a time delay based on the pre-defined time frame set by the customer.

8. The system of claim 1 wherein the main dashboard updates the at least one customer on the progress of each of the descending range of individual offers provided by the vendors.

9. The system of claim 1 wherein the at least one customer can select from the descending range of individual offers and purchase the at least one service of interest by entering transaction information.

10. The system of claim 1 wherein the at least one customer pays a transaction fee to the system.

11. The system of claim 1 wherein the least one service and/or product of interest is selected from the group consisting of: desired hotel style; availability of hotel rooms for a specific date; availability of offers and inquiry of distance to/from a point of reference.

12. A method for coordinating requirements of at least one customer related to at least one service of interest to a plurality of vendors via an online market system, the method comprising the steps of:
a) creating a customer profile in the online market system by the at least one customer;
b) creating a vendor profile in the online market system by each of the plurality of vendors;
c) entering the requirements related to the at least one service of interest by the at least one customer;
d) setting a pre-defined time frame by the at least one customer to receive an offer from at least one of the plurality of vendors;
e) validating the requirements and the pre-defined time frame by the system;
f) filtering the requirements provided by the customer and identifying a plurality of pre-qualified vendors by the system;
g) communicating the requirements to the plurality of pre-qualified vendors on a vendor dashboard and/or via a communication means;
h) accepting an offer range and one or more complementary added values by the plurality of pre-qualified vendors;
i) validating the offer ranges from the plurality of pre-qualified vendors by the system;
j) converting the offer ranges into one descending range of individual offers by means of an algorithm and publishing said individual offers to the at least one customer, said individual offers being published with a time delay based on the pre-defined time frame selected by the at least one customer;
k) selecting an offer from the descending range of individual offers and purchasing the service of interest by the customer by entering transaction information;
l) paying a transaction fee to the system by the customer;
m) encrypting customer information and transaction information and forwarding said customer information and transaction information to the vendor;
n) decrypting the customer information and the transaction information by the vendor;
o) charging the at least one customer and providing the at least one service of interest to the at least one customer by the vendor; and
p) storing transaction information in a database of the system.

13. The method of claim 12 wherein the at least one customer can view new and past offers on a main dashboard associated with the customer profile.

14. The method of claim 12 wherein each of the plurality of vendors can view new and past customer requests on the vendor dashboard associated with the vendor profile.

15. The method of claim 12 wherein the least one service of interest is selected from the group consisting of: desired hotel style; availability of hotel rooms for a specific date; availability of offers and inquiry of distance to/from a point of reference.

16. The method of claim 12 wherein the requirements pertaining to the at least one service and/or product of interest is selected from a group consisting of: name of the trip, destination, arrival and departure date, number of rooms, number of guests per room, desired hotel level, and desired maximum distance from the destination.

17. The method of claim 12 wherein the system allows the at least one customer to control and coordinate requirements related to the at least one service of interest to the plurality of vendors in a simple and efficient manner.

18. A method for providing at least one service of interest to at least one customer by a plurality of vendors via an online market system, the method comprising the steps of:
a) creating a customer profile in the online market system by the at least one customer;
b) creating a vendor profile in the online market system by each of the plurality of vendors;
c) registering the at least one service of interest in the system by entering relevant information by each of the plurality of vendors;
d) entering the requirements related to the at least one service of interest by the at least one customer;
e) setting a pre-defined time frame by the at least one customer to receive an offer from at least one of the plurality of vendors;
f) validating the requirements and the pre-defined time frame by the system;
g) filtering the requirements provided by the customer and identifying a plurality of pre-qualified vendors by the system;
h) communicating the requirements to the plurality of pre-qualified vendors on a vendor dashboard;
i) viewing the requirements on the vendor dashboard by the plurality of pre-qualified vendors;
j) providing a plurality of offer ranges and a complementary added value to the customer by at least one of the plurality of pre-qualified vendors;
k) validating each of said plurality of offer ranges from at least one of the plurality of pre-qualified vendors by the system;
l) visually alerting at least one of the plurality of pre-qualified vendors if a lower offer range from at least one of the plurality of pre-qualified vendors is validated by the system and if at least one of the plurality of vendors is still making offers to the at least one customer;
m) allowing at least one of the plurality of pre-qualified vendors to re-evaluate the offer range and re-engage the at least one customer with a lower offer range;
n) repeating step m at least one time;
o) converting the plurality of offer ranges into one descending range of individual offers by means of an algorithm and publishing said individual offers to the at least one customer, said individual offers being published with a time delay based on the pre-defined time frame selected by the at least one customer;
p) selecting an offer from the descending range of individual offers and purchasing the at least one service of interest by the customer by entering transaction information;
q) paying a transaction fee to the system by the at least one customer;
r) encrypting customer information and transaction information and forwarding said customer information and transaction information to the vendor;
s) decrypting the customer information and the transaction information by the vendor;
t) charging the at least one customer and providing the at least one service of interest to the at least one customer by the vendor; and
u) storing transaction information in a database of the system.

19. The method of claim 18 wherein the at least one customer can view new and past offers on a main dashboard associated with the customer profile.

20. The method of claim 18 wherein each of the plurality of vendors can view new and past customer requests on the vendor dashboard associated with the vendor profile.

21. The method of claim 18 wherein each of the plurality of vendors can view other competing vendors who have bid on the business and the top leading vendors in the vendor dashboard.

22. The method of claim 18 wherein the least one service of interest is selected from the group consisting of: desired hotel style; availability of hotel rooms for a specific date; availability of offers and inquiry of distance to/from a point of reference.

23. The method of claim 18 wherein the requirements pertaining to the at least one service of interest is selected from a group consisting of: name of the trip, destination, arrival and departure date, number of rooms, number of guests per room, desired hotel level, and desired maximum distance from the destination.
